(19) United States
(12) Patent Application Publication
(10) Pub. No.: US 2024/0394810 A1
(43) Pub. Date: Nov. 28, 2024

(54) APPARATUS AND METHOD FOR DETERMINING ENERGY PRICE FOR ENERGY TRADING SYSTEM ON SHARING BASIS

(71) Applicant: Gemvaxlink Co., Ltd., Seoul (KR)

(72) Inventors: Ki-Hyun KIM, Seoul (KR); Young-Jin JANG, Seoul (KR); Yong-Bo SHIM, Bucheon-si (KR); Ha-Eun KIM, Incheon (KR); Su-Hee KIM, Uiwang-si (KR)

(21) Appl. No.: 18/397,292

(22) Filed: Dec. 27, 2023

(30) Foreign Application Priority Data
Apr. 26, 2023 (KR) 10-2023-0054517

(51) Int. Cl. G06Q 50/06; G06Q 20/08; G06Q 30/0201

(52) U.S. Cl. CPC G06Q 50/06; G06Q 20/085; G06Q 30/0206

(57) ABSTRACT

Disclosed is an apparatus for determining an energy cost applied to an energy sharing transaction system which performs a secondary energy sharing transaction between a seller and a buyer having an energy production facility which is operated by using primary energy as a power source to produce secondary energy. The apparatus for determining an energy unit price comprising: a data collection unit for collecting a plurality of data used to calculate the energy unit price for the energy sharing transaction; a prediction data calculation unit which generates maintenance data for maintaining a quality of the secondary energy existing in an energy transportation pipe at a predetermined time interval by accumulating measurement data of a plurality of meters installed in the energy transportation pipe where the secondary energy is transferred, the energy transportation pipe being connected between the secondary energy production facility and a factory of the buyer; and a unit price calculation unit for calculating the energy unit price of the secondary energy supplied from the secondary energy production facility by using at least a part of the data collected by the data collection unit and at least a part of the data generated by the prediction data calculation unit.

### TECHNICAL FIELD

The present invention relates to an apparatus and a method for determining an energy unit price for an energy sharing transaction system and, more specifically, to an apparatus and a method for determining an energy unit price for an energy sharing transaction system, which can determine a unit price of energy in an energy sharing transaction system which enables a sharing transaction of energy between a factory having extra energy in a certain area such as an industrial complex and a factory having insufficient energy, and can provide the unit price to the transaction parties.

### BACKGROUND ART

In general, various energy such as steam and compressed air in addition to energy such as petroleum, natural gas, electricity, etc. are required for operating a production facility in a factory.

Factories produce and consume necessary energy. Due to the difference in energy production per factory, some factories can produce more energy than the energy consumed by themselves while some other factories produce insufficient amount of energy than the energy consumed by them.

If a factory has the capacity to produce more energy than it consumes, its energy production facility may not be fully utilized because it generates less energy than its capacity. Furthermore, if a factory lacks an energy production facility capable of meeting its energy demands, it may be unable to operate at full capacity, or it may incur additional costs to expand its energy production facilities.

To solve this problem, the applicant of the present application has filed a Korean patent application No. KR 10-2022-0126659 entitled “Energy Sharing Transaction System and Method” on Oct. 4, 2022. In the described energy sharing transaction system, both the energy seller and buyer encounter challenges in determining the price of energy. There hasn't been an established market for secondary energy (such as steam, compressed air, etc.) produced by using primary energy sources (such as electricity, gas, etc.). Furthermore, transactions involving secondary energy haven't materialized due to impracticalities in its delivery. Consequently, if a factory requires such secondary energy, it must invest in constructing facilities for its production.

Recently, environmental laws are being developed or planned to regulate and manage carbon emissions associated with various forms of secondary energy. These laws aim to support emerging markets such as greenhouse gas reduction, new renewable energy transactions, and carbon credit transactions. Consequently, there is a need to establish methods and standards for determining unit prices for different types of secondary energy sources.

The matters described as background technology above are only for the purpose of improving understanding of the background of the present invention, and should not be taken as recognition that they correspond to prior art already known to those skilled in the art.

### SUMMARY OF THE INVENTION

### Problem to be Solved

The objective of the present invention is to provide an apparatus and a method for determining an energy unit price for an energy sharing transaction system, which can determine a unit price of secondary energy by reflecting various factors in an energy sharing transaction system capable of trading various kinds of secondary energy and provide the unit price to transaction parties.

### Solution to Solve Problem

As an aspect for achieving the above objects, the present invention provides an apparatus for determining an energy unit price applied to an energy sharing transaction system for executing a secondary energy sharing transaction between a buyer and a seller having a secondary energy production facility operated by using a primary energy as a power source to produce a secondary energy, the apparatus comprising: a data collection unit for collecting a plurality of data used to calculate the energy unit price for the energy sharing transaction; a prediction data calculation unit which generates maintenance data for maintaining a quality of the secondary energy existing in an energy transportation pipe at a predetermined time interval by accumulating measurement data of a plurality of meters installed in the energy transportation pipe where the secondary energy is transferred, the energy transportation pipe being connected between the secondary energy production facility and a factory of the buyer; and a unit price calculation unit for calculating the energy unit price of the secondary energy supplied from the secondary energy production facility by using at least a part of the data collected by the data collection unit and at least a part of the data generated by the prediction data calculation unit.

In an embodiment of the present invention, the plurality of data collected by the data collection unit comprises at least one of: a unit price of the primary energy used to operate the secondary energy production facility, a supply time pattern and an issue schedule of the secondary energy, diagnosis information and manual information of the secondary energy production facility, the measurement data, a cost or a reward generated when the seller subscribes to the energy sharing transaction system, and a carbon credit payment cost of the seller.

In an embodiment of the present invention, the plurality of meters comprise at least one of a flowmeter, a manometer, a thermometer and a vibrometer.

In an embodiment of the present invention, the prediction data calculation unit is adapted to accumulate the measurement data collected in real-time and predict an operation cost of an auxiliary facility for maintaining temperature or pressure in the transportation pipe read from the measurement data at a preset level or higher monthly or seasonally.

In an embodiment of the present invention, the unit price calculation unit is adapted to calculate an amount of the primary energy used by the secondary energy production facility according to an equation:

$${E}_{1} = \frac{{V}_{p} \times ( {E}_{i} / \sum {E}_{n} ) \times {r}_{L 1} \times {r}_{i}}{{V}_{s}} \times \frac{W}{{r}_{E} \times {r}_{Ei}}$$

wherein
E₁ represents a used amount per unit time of one primary energy among a plurality of primary energies used to operate the secondary energy production facility;
Vₚ represents a supplied amount of the secondary energy sold through the energy sharing transaction system;
Eᵢ represents energy amount of a corresponding primary energy;
ΣEₙ represents a summed amount of each energy amount of the plurality of primary energies consumed to produce the secondary energy;
r_{L1} represents a facility load factor of the secondary energy production facility;
rᵢ represents an operating rate of a primary energy production facility 1 if the primary energy production facility does not exist;
Vₛ represents a production capacity of the secondary energy production facility;
W represents a consumption of primary energy per unit time of a preset secondary energy production facility;
r_{E} represents an efficiency of the secondary energy production facility; and
r_{Ei} represents an efficiency of a corresponding primary energy production facility 1 if the primary energy production facility does not exist.

In an embodiment of the present invention, the unit price calculation unit is adapted to determine the energy unit price of the secondary energy produced by the secondary energy production facility during a predetermined period for calculation of the energy unit price by applying an operational pattern of the primary energy production facility during the period and the unit price of the primary energy.

In an embodiment of the present invention, the unit price calculation unit is adapted to calculate an amount of the primary energy consumed by the auxiliary facility according to an equation:

$${E}_{2} = \frac{{r}_{L 2} \times \sum ( {W}_{j} \times {r}_{j \_ o} \times {r}_{j \_ e} )}{{T}_{L}}$$

wherein
E₂ represents a used amount per predetermined time of the primary energy used to operate the auxiliary facility;
r_{L2} represents a facility load factor of the auxiliary facility;
Wⱼ represents a consumed power by one of a plurality of the auxiliary facilities;
r_{J_o} represents an operating rate of a corresponding auxiliary facility;
r_{j_e} represents an efficiency of the corresponding auxiliary facility; and
T_{L} represents a load time of the auxiliary facility.

In an embodiment of the present invention, the unit price calculation unit is adapted to divide a purchase cost or installation cost of the secondary energy production facility and an auxiliary facility by a preset term of usage and apply an supply pattern of the secondary energy to calculate a depreciation cost during a period for calculation of the energy unit price, and then apply the depreciation cost as an item of a transaction price applied to an energy sharing transaction.

In an embodiment of the present invention, the unit price calculation unit is adapted to apply a cost for maintaining the quality of the secondary energy in the transportation pipe predicted at a predetermined time interval by the prediction data calculation unit as an item of a transaction price applied to an energy sharing transaction.

In an embodiment of the present invention, the unit price calculation unit is adapted to receive data on maintenance cost for the secondary energy production facility or the auxiliary facility, a transaction participation cost, and an environmental cost and calculate the maintenance cost, the participation cost and the environmental cost corresponding to a period for calculation of the energy unit price based on an operational pattern of a corresponding facility to apply the calculated costs as items of a transaction price applied to the energy sharing transaction.

As another aspect for achieving the above objects, the present invention provides a method for determining an energy unit price applied to an energy sharing transaction system for executing a secondary energy sharing transaction between a buyer and a seller having a secondary energy production facility operated by using a primary energy as a power source to produce a secondary energy, the method comprising: a data collection step of collecting a plurality of data used to calculate the energy unit price for the energy sharing transaction; a prediction data calculation step of generating maintenance data for maintaining a quality of the secondary energy existing in an energy transportation pipe at a predetermined time interval by accumulating measurement data of a plurality of meters installed in the energy transportation pipe where the secondary energy is transferred, the energy transportation pipe being connected between the secondary energy production facility and a factory of the buyer; and a unit price calculation step of calculating the energy unit price of the secondary energy supplied from the secondary energy production facility by using at least a part of the data collected by the data collection step and at least a part of the data generated by the prediction data calculation unit.

### EFFECTS OF THE INVENTION

According to the apparatus and the method for determining an energy unit price for an energy-sharing transaction system, it becomes feasible to alter the operational behavior of factories that receive secondary energy. Additionally, it enables the establishment of multiple sellers for each type of secondary energy, thereby allowing for the adjustment of peak energy usage periods.

In addition, according to the apparatus and the method for determining the energy unit price for the energy-sharing transaction system, the assurance of information transparency regarding facility management and carbon emissions for each company can be enabled. This is achieved through the requirement of inputs for various factors such as operational ratios, load factor inputs, efficiency of older facilities, and similar parameters. Additionally, it facilitates the generation of more statistics and reports related to carbon emissions within the manufacturing industry field through diverse market price formation mechanisms.

In addition, according to the apparatus and the method for determining the energy unit price for the energy-sharing transaction system, it becomes possible to update not only the application period of the variable cost of primary energy but also the transaction cost for each transaction group based on intention and purpose. This flexibility allows for adjustments to the usage pattern of companies utilizing secondary energy in alignment with the supplier's pattern.

Furthermore, according to the apparatus and the method for determining the energy unit price for the energy-sharing transaction system, it becomes feasible to derive and establish an environment and pattern conducive to optimal energy cost reduction between sellers and buyers, as well as for each region within a transactional factory group.

The effects obtained by the present invention are not limited to the above-mentioned effects, and other effects not mentioned can be clearly understood by a person skilled in the art to which the present invention belongs from the following description.

### BRIEF DESCRIPTION OF THE DRAWINGS

FIG. 1 illustrates an exemplary energy sharing transaction system example applying the apparatus and method for determining energy unit price according to an embodiment of the present invention.

FIG. 2 is a block diagram illustrating a transaction server of the energy sharing transaction system illustrated in FIG. 1 in more detail.

FIG. 3 is a block diagram of an apparatus for determining an energy unit price for an energy sharing transaction system according to an embodiment of the present invention.

FIG. 4 is a flowchart illustrating a method for determining an energy unit price for an energy sharing transaction system according to an embodiment of the present invention.

### DETAILED DESCRIPTION OF THE INVENTION

Hereinafter, an apparatus and a method for determining an energy unit price for an energy sharing transaction system according to various embodiments of the present invention will be described in more detail with reference to the accompanying drawings.

The advantages and characteristic features of the present invention, and methods of achieving the same, will become apparent with reference to the embodiments described in detail with the accompanying drawings.

However, the present invention is not limited to the embodiments disclosed below and will be implemented in various forms. The present embodiments only serve to complete the disclosure of the present invention and are provided to inform the scope of the invention to a person skilled in the art to which the present invention pertains. The present invention is only defined by the scope of the claims.

Additionally, if it is determined that discussing related known techniques may obscure the essence of the present invention, detailed descriptions thereof will be omitted in the following description.

Firstly, an energy sharing transaction system to which an embodiment of the present invention is applied is described to help understanding of an apparatus and a method for determining an energy unit price for an energy sharing transaction system according to an embodiment of the present invention.

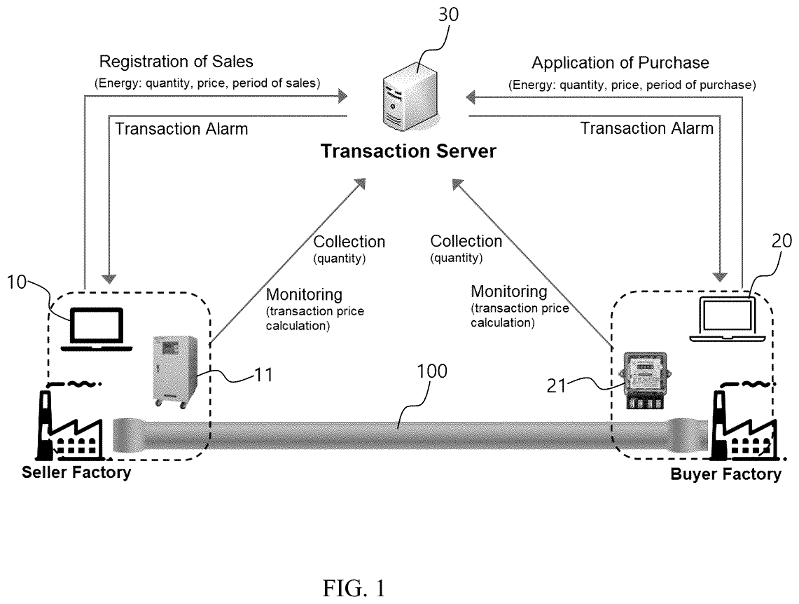

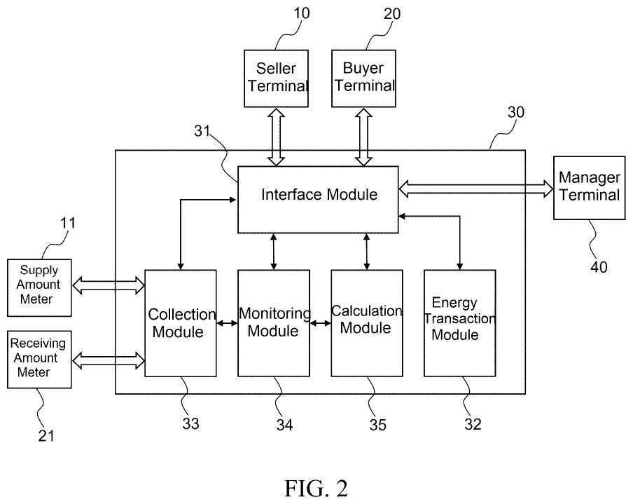

FIG. 1 is a block diagram illustrating an example of an energy sharing transaction system to which an apparatus and a method for determining an energy unit price for an energy sharing transaction system according to an embodiment of the present invention are applied, and FIG. 2 is a block diagram illustrating a transaction server of the energy sharing transaction system illustrated in FIG. 1 in more detail.

The configurations of the system and the transaction server shown in FIGS. 1 and 2 are disclosed in the Korean patent application No. KR 10-2022-0126659 entitled “Energy Sharing Transaction System and Method” filed by the applicant of the present application on Oct. 4, 2022.

Referring to FIGS. 1 and 2, an energy sharing transaction system to which an embodiment of the present invention is applied may comprise: a seller terminal 10 for inputting selling information, facilitating the registration of energy sales originating from a selling factory by sellers seeking to vend energy; a buyer terminal 20 for receiving purchasing information pertaining to energy procurement applications intended for supply to the buying factory, submitted by buyers seeking to acquire energy; and a transaction server 30 for receiving the selling information and the purchasing information from the seller terminal 10 and the buyer terminal 20, respectively, and facilitate the conclusion of an energy trading contract between the seller and the buyer, based on the received selling and the buying information.

The seller terminal 10 is utilized by the seller-factory-side engaged in energy production for sale, and it can establish connectivity to enable data communication with the transaction server 30 through a communication network, such as the Internet or an intranet.

The seller terminal 10 can access the transaction server 30 through an input interface provided by the transaction server 30. The seller terminal 10 can receive various energy selling information, such as the selling factory's name, type of energy being sold, selling price, selling period, selling quantity, and more. It then transmits this information to the transaction server 30, facilitating the registration of the energy sale. Additional items may be included or some of the items described above may be omitted depending on the type of transaction model for the energy transaction.

Here, the seller terminal 10 may be implemented as a desktop computer, a laptop computer, a smart phone, a smart pad, or the like connected to a communication network so as to enable data communication with the transaction server 30 in a wired or wireless manner.

The buyer terminal 20 is employed by the buyer-factory-side and can establish a connection with the transaction server 30 via a communication network such as the Internet or an intranet.

The buyer terminal 20 can establish a connection with the transaction server 30 through an input interface provided by the transaction server 30. It receives certain energy purchase information, such as the buying factory's name, selected energy type, buying period, purchase capacity, and more. Subsequently, it transmits this information to the transaction server 30, thus initiating the energy purchase application process. Various items may be added or some of the aforementioned items may be removed based on the specific transaction model for the energy transaction.

Like the seller terminal 10, the buyer terminal 20 may be implemented as a desktop computer, laptop computer, smartphone, tablet, or similar devices connected to a communication network, facilitating data communication with the transaction server 30 via wired or wireless connections.

The transaction server 30 receives sales information from the seller terminal 10 and purchase information from the buyer terminal 20, respectively, and facilitates an energy transaction between the seller and the buyer.

More specifically, the transaction server 30 may consist of: an interface module 31, which offers an interface allowing the seller terminal 10 and the buyer terminal 20 to input and review essential information by accessing the transaction server 30; and an energy transaction module 32, responsible for facilitating an energy sharing transaction between the seller and the buyer based on the selling information provided by the seller terminal 10 and the purchase information provided by the buyer terminal 20.

The interface module 31 serves to create a webpage visible on both the seller terminal 10 and the buyer terminal 20. It presents a form capable of receiving input information from the seller and the buyer on both terminals. Additionally, it generates a screen to display transaction outcomes and statuses between the seller and the buyer, which is then showcased on the seller terminal 10 and the buyer terminal 20. For instance, the interface module 31 delivers necessary information to the seller terminal 10 and the buyer terminal 20 by constructing and exhibiting a screen accessible through an application or web browser installed on both terminals.

The energy transaction module 32 is responsible for programming various preset transaction models and facilitating the execution of an energy sharing transaction based on input information from the seller terminal 10 and the buyer terminal 20. Further elaboration on the transaction model implemented by the energy trading module 32 in various embodiments of the present invention will be provided subsequently.

Meanwhile, an embodiment of the present invention may further include a supply amount measuring device 11 installed in a selling factory, a receiving amount measuring device 21 installed in a purchasing factory, and a manager terminal 40 receiving various settings required for an energy sharing transaction from a manager overseeing the transaction server 20.

The supply amount measuring device 11, located at the selling factory for supplying energy via an energy transaction, is installed to gauge the actual amount of energy delivered through the energy transportation pipe 100 within the selling factory. Likewise, the receiving amount measuring device 21, situated at the purchasing factory involved in energy transactions, is installed to measure the amount of energy received by the purchasing factory through the energy transportation pipe 100.

The transaction server 30 may further comprise: a collection module 33 for receiving, in real time, data on the amount of energy measured by the supply amount measuring device 11 and the receiving amount measuring device 21; and a monitoring module 34 for monitoring an energy transaction state on the basis of the collected energy transaction amount data. The monitoring module 34 is capable of overseeing the energy supply quantity from the selling factory, as gathered by the collecting module 33, and the energy demand quantity of the buying factory. It assesses for any abnormalities and computes and stores the accumulated supply quantity and accumulated receiving quantity of energy for each period.

Additionally, the transaction server 30 may incorporate a calculation module 35 responsible for computing the energy sale profit to be remitted to the energy seller and the energy purchase fee to be levied on the energy buyer. This calculation is based on the accumulated supply quantity and accumulated received quantity of energy for each period, determined by the monitoring module 34. The calculation module 35 may determine the energy sale profit and energy purchase fee according to a predetermined charging model.

In the energy sharing transaction system outlined above, an energy unit price determination apparatus and method, as per an embodiment of the present invention, can ascertain a unit price for energy production. This unit price can be employed to establish a fee model and provided to transaction participants, thereby offering reference data for determining fees.

The energy unit determination apparatus, as outlined in an embodiment of the present invention, can be integrated into the transaction server 30 within the energy sharing transaction system described above. For instance, the energy unit price determination device, according to an embodiment of the present invention, could be situated within the calculation module 35 and presented in the form of a price table for use in referencing the transaction price settlement between the seller and the buyer.

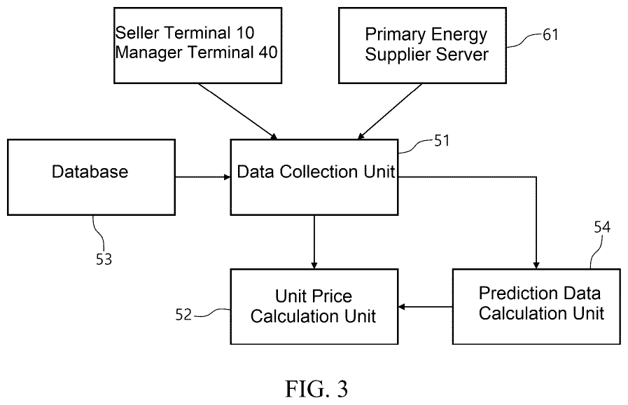

FIG. 3 is a block diagram of an apparatus for determining an energy unit price for an energy sharing transaction system according to an embodiment of the present invention.

Referring to FIG. 3, a device for determining an energy unit price for an energy sharing transaction system according to an embodiment of the present invention comprises: a data collection unit 51 for collecting various data for setting an energy transaction unit price; and a unit price calculation unit 52 for determining an energy price by using the data collected by the data collection unit 51, employing a predefined energy unit price calculation equation.

The data collection unit 51 can collect various types of data for determining an energy transaction cost from various data sources.

As a specific example, the data collected by the data collection unit 51 can be as follows.
1. The unit price of energy utilized to operate the energy production facility (hereinafter, the energy used to operate the facility is referred to as primary energy (e.g., electricity, gas, water, etc.), and the energy produced by the facility operated by using the primary energy as a power source is referred to as secondary energy (e.g., compressed air, steam, etc.))
2. A secondary energy supply time pattern and an issue schedule (for example, the date on which the supply of secondary energy is halted due to holidays, facility maintenance, or other reasons)
3. Diagnostic information and manual instructions pertain to the production facility itself for generating secondary energy (e.g., pre-reviewed and established data for energy production facilities (e.g., those on the energy-seller-side) which operate using primary energy as a power source to produce second energy)
4. Various meter data related to the supply of secondary energy (e.g., measurement data from instruments such as flowmeters, manometers, thermometers, a vibrometers, etc.)
5. Transaction participation fee: a deposit paid by a secondary energy seller, a paid subsidy or reward (mileage) to use the energy sharing transaction system
6. Environmental cost: cost paid by secondary energy seller for protection of climate environment such as carbon credit payment

In addition to the provided data, the data collection unit 51 can gather various additional data and derivative data as required.

In an embodiment of the invention, the unit price of the primary energy may be periodically collected from a primary energy provider server 61 external to the energy sharing transaction system. For instance, if the primary energy is electricity, the data collection unit 51 may periodically retrieve the electricity tariff costs for each supply period from the server of the electricity supply company. Similarly, when the primary energy is natural gas, the data collection unit 51 can periodically gather the natural gas prices from the server of the natural gas supply company in the respective region.

The frequency of collecting the unit price of the primary energy can be adjusted based on the price change cycle of the primary energy supply company.

In an embodiment of the present invention, the secondary energy supply time pattern and the issue schedule may be received from a seller or a manager. In the system of FIG. 1, a data collection unit 51 may receive data input by a seller and a manager through a seller terminal 10 and a manager terminal 40, respectively. The supply time pattern and the issuance schedule may be used to identify an operating time of the facility during a particular time unit, such as monthly intervals.

In an embodiment of the present invention, the diagnostic information or manual information for the production facility itself for producing the secondary energy may encompass details about the secondary energy production facility. This includes information such as the construction cost, service life, optimal production capacity, maintenance cost, and other relevant parameters associated with the secondary energy production facility.

The embodiment of the present invention may further include a database 53 for storing diagnosis information or manual information about the secondary energy production facility in advance. The database 53 may be implemented within a storage device provided within the transaction server 30 of FIG. 1. The data collection unit 51 can read diagnosis information or manual information about the production facility itself for producing the secondary energy stored in the database 53 to calculate the transaction unit price of the secondary energy.

In an embodiment of the present invention, various measurement data related to the supply of secondary energy (for example, measurement data from instruments such as flowmeters, pressure gauges, thermometers, vibrometers, etc.) are utilized to generate real-time or accumulated data necessary for determining a transaction price. Additionally, time-specific application data is generated based on the accumulated data thus produced. For example, the data of the flowmeter installed in the energy transportation pipe 100 for the energy sharing transaction can be used to derive the amount of secondary energy supply (sales quantity) required for the calculation of the energy transaction price. As another example, data obtained from instruments such as pressure gauges, thermometers, and vibrometers installed in the energy transportation pipe 100 may be utilized to generate information for calculating costs necessary to maintain the quality of secondary energy within the pipe for each time period. This is achieved by generating accumulated data for each time interval.

To generate the necessary cost calculation data for managing the quality of secondary energy for each time period (monthly, seasonally, etc.) through the accumulation of data detected by various measuring devices, the present invention may additionally include a prediction data calculation unit 54.

In particular, the prediction data calculation unit 54 can calculate a secondary energy maintenance cost. The secondary energy present in the energy transportation pipe 100 is immediately supplied to the buyer to be maintained at a predetermined level or higher so that the secondary energy can be utilized as energy. For instance, in the case of steam, it's essential to maintain a temperature at or above a predetermined level, while for compressed air, a pressure at or above a certain threshold must be upheld. This ensures that the secondary energy within the energy transportation pipe 100 is adequately maintained, facilitating energy transactions.

In order to ensure the quality of the secondary energy within the energy transportation pipe 100, the prediction data calculation unit 54 receives measurement data from instruments such as a pressure gauge, a thermometer, and a vibrometer installed in the energy transportation pipe 100. Additionally, it gathers information on the operational costs associated with maintaining the quality of secondary energy, corresponding to the aforementioned measurement data, from either the data collection unit 51 or the unit price calculation unit 52, as described later. Subsequently, it accumulates and monitors this data, generating predictions regarding the costs required for maintaining the quality of secondary energy and supplying secondary energy based on data specific to particular seasons, months, etc.

Once data reaching or exceeding predetermined levels is accumulated, the prediction data calculation unit 54 forecasts the operational costs associated with maintaining the quality of secondary energy corresponding to the measurement data acquired from instruments like a pressure gauge, a thermometer, and a vibrometer from the data collection unit 51, utilizing the accumulated prediction data, and transmits the estimated costs to the final calculation unit 52.

In an embodiment of the present invention, the transaction participation fee refers to a deposit paid by the secondary energy seller to utilize the energy sharing transaction system, or received subsidies, rewards (points), etc., unrelated to energy production but may influence the determination of energy transaction prices. The data collection unit 51 can gather such information through reflection of system usage costs indicated in contracts between system administrators and sellers, government policies, reward information, etc.

In an embodiment of the present invention, the climate/environmental fee refers to the cost paid by the secondary energy seller for climate/environmental protection, such as carbon emission permits. The data collection unit 51 can directly obtain this information from the secondary energy seller.

The unit price calculation unit 52 receives data collected by the data collection unit 51 and data predicted by the prediction data calculation unit 54. It applies an algorithm, typically based on a preset equation or a reference table, to calculate the transaction price of the secondary energy. Subsequently, it furnishes the basic transaction unit price information to the seller participating in the energy sharing transaction.

Firstly, the unit price calculation unit 52 can compute the usage of the primary energy required to operate the production facility of the secondary energy and calculate the usage of primary energy employed to operate the auxiliary equipment necessary for energy sharing transactions other than the production facilities of secondary energy.

For example, the unit price calculation unit 52 can compute the primary energy consumption of the secondary energy production facility using the following Equation 1, and determine the primary energy usage of the auxiliary equipment using the following Equation 2.

$${E}_{1} = \frac{{V}_{p} \times ( {E}_{i} / \sum {E}_{n} ) \times {r}_{L 1} \times {r}_{i}}{{V}_{s}} \times \frac{W}{{r}_{E} \times {r}_{Ei}} \qquad [ Equation 1 ]$$

$${E}_{2} = \frac{{r}_{L 2} \times \sum ( {W}_{j} \times {r}_{j \_ o} \times {r}_{j \_ e} )}{{T}_{L}} \qquad [ Equation 2 ]$$

In Equation 1, “E₁” represents the amount of primary energy usage per unit time of primary energy used to operate the secondary energy production facility. Primary energy used to operate the secondary energy production facility can be various types such as electricity, gas, water, heat, etc. “i” means one of several primary energies required for secondary energy production. “_{V}P” represents the volume of secondary energy sales supply facilitated through the energy sharing transaction system of the produced secondary energy. In addition, “Eᵢ” represents an amount of energy of one of the primary energies, “ΣEₙ” represents a value obtained by summing up the amount of energy of the various types of primary energy consumed to produce secondary energy. Here, the amount of energy may vary depending on the type of energy, but it can be converted into a single energy unit using conversion standards such as those specified in Article 5 of the Enforcement Rules of the Energy Act in Korea. “r_{L1}” represents the facility load factor of the secondary energy production facility, and “rᵢ” represents the operating ratio of primary energy production facilities when such facilities exist. In the case of primary energy like electricity or gas, which can be directly received from external facilities without the need for production facilities themselves, “rᵢ” may have a value of 1. However, for energy types such as water, where equipment operation such as motor operation is required when the energy itself is stored in specific storage tanks, the operating ratio of the relevant equipment may be applied to the rᵢ. “Vₛ” represents the consumption of primary energy per unit time of a preset secondary energy production facility, “r_{E}” represents the efficiency of the secondary energy production facility, and “r_{Ei}” represents the efficiency of the primary energy production facility when such facilities exist. In the case of primary energy where there is no production facility, the “r_{Ei}” may have a value of 1.

Here, the sales supply volume of secondary energy can be collected by the data collection unit 51 through direct input by the seller via their terminal. The facility load factor can be directly input to the data collection unit 51 from control units of production facilities. Additionally, the production capacity, power consumption, and efficiency of production facilities can be collected by the data collection unit 51 from diagnostic or manual information of the secondary energy production facilities stored in the database 53 beforehand.

In Equation 2, “E₂” is an amount of primary energy used per a predetermined time of primary energy used to operate an auxiliary facility for producing secondary energy, and “r_{L2}” represents a facility load factor of the auxiliary facility. “Wⱼ” represents consumed power by one of a plurality of auxiliary facilities, “r_{j_o}” represents an operating rate of the corresponding auxiliary facility, “r_{j_e}” represents an efficiency of the corresponding auxiliary facility, and “T_{L}” represents a load time of the auxiliary facility. The auxiliary facilities can vary and may include devices such as a pressure gauge, a power meter, a controller, a communicator, a flowmeter, a thermometer, a vibrometer, and the like. The load time can be changed appropriately to a time unit for providing a transaction price as needed.

The facility load factor and operating rate of auxiliary facilities can be directly input to the data collection unit 51 from controllers managing these facilities. Additionally, the data collection unit 51 can retrieve power consumption data from devices such as pressure gauges, power meters, controllers, communicators, flowmeters, thermometers, vibrometers, and the efficiency of these auxiliary facilities from diagnostic or manual information stored in the database 53. Operating days or hours can be input to the data collection unit 51 by the seller directly entering operational patterns of the facility.

The unit price calculation unit 52 can calculate the electricity consumption per unit time through primary energy consumption calculated using Equation 1. For example, by applying the time unit (e.g., one month) for calculating the preset transaction unit price based on the operating patterns in Equation 1, the primary energy usage of the secondary energy production facility during the time unit of the preset transaction unit price calculation can be calculated. Then, by applying the unit price of the primary energy received through the primary energy supplier server to the calculated primary energy usage, the production cost of the secondary energy for one month can be determined. The determined production cost of the secondary energy can be applied as one item of the transaction unit price applied in energy sharing transactions.

Furthermore, the unit price calculation unit 52 can apply the calculated operating cost of auxiliary equipment for one month, computed via Equation 2, as one item of the transaction unit price applied in energy sharing transactions.

Furthermore, the unit price calculation unit 52 can divide the purchase cost or installation cost of the secondary energy production facility and auxiliary equipment by a pre-set useful life obtained from the database 53, apply the pattern of secondary energy supply, calculate the depreciation expense for one month during the time unit of transaction price calculation, and apply it as one component of the transaction unit price applied in energy sharing transactions.

Furthermore, the unit price calculation unit 52 can apply the maintenance cost of secondary energy within the energy transmission pipe 100, predicted by the prediction data calculation unit 54 on a pre-set time basis such as monthly or seasonal, as one component of the transaction unit price applied in energy sharing transactions.

Additionally, the unit price calculation unit 52 can also receive data regarding maintenance costs for secondary energy production facilities or auxiliary facilities, transaction participation fees, and climate/environmental charges, and calculate each of them as monthly costs based on the operation patterns of the facilities. These costs can then be applied as components of the transaction unit price used in energy sharing transactions.

Embodiments of the present invention also provide a method for determining an energy unit price for an energy sharing transaction system, which is implemented by the apparatus for determining an energy unit for an energy sharing transaction system as described above.

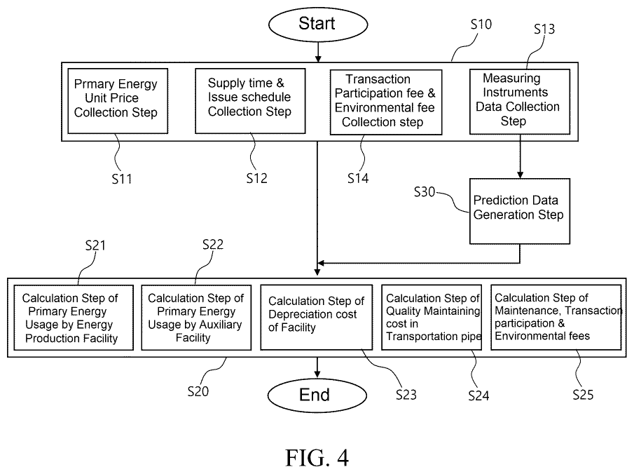

FIG. 4 is a flowchart illustrating a method for determining an energy unit price for an energy sharing transaction system according to an embodiment of the present invention.

Referring to FIG. 4, an energy unit price determination method for an energy sharing transaction system according to an embodiment of the present invention may comprise: a data collection step S10 of collecting various data used for a data collection unit 51 to apply a transaction price of energy traded in a sharing transaction system; and a transaction unit price determining step S20 of determining several items capable of determining an energy transaction cost by using the collected data.

In the data collection step S10, the data collection unit 51 can periodically collect the unit price of primary energy from a primary energy provider server 61 outside the energy sharing transaction system (S11). In step S11, the frequency of collecting the unit price of primary energy can vary according to the price change cycle of the primary energy supplier.

In addition, in the data collection step S10, the data collection unit 51 can receive a secondary energy supply time pattern and an issuance schedule from a seller or a manager (S12). In step 512, the supply time pattern and the issue schedule may be used to identify the operating time of the facility during a specific time unit (e.g., monthly) for generating transaction prices.

Furthermore, in the data collection step S10, the data collection unit 51 can gather diagnostic information or manual information for the production facility required to produce secondary energy from the database 53. Here, the diagnostic information or manual information for the production facility may encompass details regarding the construction cost of the facilities required for secondary energy production, the service life of both the secondary energy production facilities and the auxiliary facilities, the optimal production capacity of the secondary energy production facilities, and the maintenance cost for both the secondary energy production facilities and auxiliary facilities.

Also, in the data collection step S10, the data collection unit 51 can receive various instrument data related to the supply of secondary energy, such as data measured from instruments like flow meters, pressure gauges, thermometers, vibrometers, etc. (S13).

The embodiment of the present invention may further comprise a step S30 of generating prediction data corresponding to the cost required to maintain the quality of energy in the energy transportation pipe by using the instrument data.

In step S30, the prediction data calculation unit 54 can accumulate real-time data collected in the step S13 to generate accumulate data, and based on the generated accumulated data, it can create data applicable to transaction prices on a periodic basis (monthly, seasonal, etc.) to be applied to the transaction price. For example, in step S30, the prediction data calculation unit 54 can compute the maintenance cost of secondary energy. The secondary energy present within the energy transportation pipe 100 must maintain a quality level above a certain threshold to be immediately supplied to the buyer and utilized as energy. For instance, in the case of steam, a temperature above a certain level must be maintained, while for compressed air, a pressure above a certain level must be maintained. In this way, ensuring that the secondary energy within the energy transportation pipe 100 is maintained at a sufficient quality level enables energy transactions to take place.

To maintain the quality of the secondary energy within the energy transportation pipe 100, in step S30, the prediction data calculation unit 54 can accumulate and manage the measurement data from instruments such as pressure gauges, thermometers, vibrometers installed in the energy transportation pipe 100, along with the operating costs of the equipment for maintaining the quality of secondary energy. This information can be obtained from the data collection unit 51 or the subsequent unit price calculation unit 52. By doing so, the prediction data calculation unit 54 can generate data predicting the costs associated with maintaining and supplying the quality of secondary energy based on specific data for certain seasons, specific months, and other relevant factors.

In step S30, the prediction data computation unit 54 can predict the operational cost of the equipment for maintaining the quality of secondary energy corresponding to the accumulated prediction data when a certain level of data has been accumulated, utilizing the measurement data such as pressure gauge, thermometer, and vibrometer received from the data collection unit 51 as accumulated prediction data.

Additionally, in the data collection step S10, the data collection unit 51 can receive transaction participation costs (energy external costs that may influence the energy transaction price but are not directly related to energy production, such as deposits paid by secondary energy sellers to utilize the energy sharing transaction system or subsidies or rewards (points) received) through contracts between system administrators and sellers, or information about rewards provided by previous systems. Moreover, the data collection unit 51 can collect climate/environmental fees corresponding to costs incurred by secondary energy sellers for environmental protection, such as carbon emission rights (S14).

In the unit price calculation step S20, the unit price calculation unit 52 receives the data collected in the data collection step S10 and the data predicted by the prediction data calculation unit 54 in the step S30, and performs an algorithm applied to a preset equation or a reference table for the calculation of the transaction price of the secondary energy to provide the basic transaction price information to the transaction party (e.g., seller) of the energy sharing transaction.

First, in the unit price calculation step S20, the unit price calculation unit 52 calculates the usage of primary energy used to operate the secondary energy production facilities (S21). It can also compute the usage of primary energy required to operate auxiliary equipment for energy sharing transactions other than the secondary energy production facilities (S22) Equations applicable in steps S21 and S22 are represented by Equation 3 and Equation 4, respectively.

For example, in steps S21 and S22, the unit price calculation unit 52 can calculate the usage of primary energy for the secondary energy production facilities as shown in Equation 3and compute the usage of primary energy for the auxiliary equipment as illustrated in Equation 4.

$${E}_{1} = \frac{{V}_{p} \times ( {E}_{i} / \sum {E}_{n} ) \times {r}_{L 1} \times {r}_{i}}{{V}_{s}} \times \frac{W}{{r}_{E} \times {r}_{Ei}} \qquad [ Equation 3 ]$$

$${E}_{2} = \frac{{r}_{L 2} \times \sum ( {W}_{j} \times {r}_{j \_ o} \times {r}_{j \_ e} )}{{T}_{L}} \qquad [ Equation 4 ]$$

In Equation 3, “E₁” represents the amount of primary energy usage per unit time of primary energy used to operate the secondary energy production facility. Primary energy used to operate the secondary energy production facility can be various types such as electricity, gas, water, heat, etc. “i” means one of several primary energies required for secondary energy production. “V_{P}” represents the volume of secondary energy sales supply facilitated through the energy sharing transaction system of the produced secondary energy. In addition, “Eᵢ” represents an amount of energy of one of the primary energies, “ΣEₙ” represents a value obtained by summing up the amount of energy of the various types of primary energy consumed to produce secondary energy. Here, the amount of energy may vary depending on the type of energy, but it can be converted into a single energy unit using conversion standards such as those specified in Article 5 of the Enforcement Rules of the Energy Act in Korea. “r_{L1}” represents the facility load factor of the secondary energy production facility, and “rᵢ” represents the operating ratio of primary energy production facilities when such facilities exist. In the case of primary energy like electricity or gas, which can be directly received from external facilities without the need for production facilities themselves, “rᵢ” may have a value of 1. However, for energy types such as water, where equipment operation such as motor operation is required when the energy itself is stored in specific storage tanks, the operating ratio of the relevant equipment may be applied to the rᵢ. “Vₛ” represents the consumption of primary energy per unit time of a preset secondary energy production facility, “r_{E}” represents the efficiency of the secondary energy production facility, and “r_{Ei}” represents the efficiency of the primary energy production facility when such facilities exist. In the case of primary energy where there is no production facility, the “r_{Ei}” may have a value of 1.

In step S21, the sales supply volume of secondary energy can be collected by the data collection unit 51 through direct input by the seller via their terminal. The facility load factor can be directly input to the data collection unit 51 from control units of production facilities. Additionally, the production capacity, power consumption, and efficiency of production facilities can be collected by the data collection unit 51 from diagnostic or manual information of the secondary energy production facilities stored in the database 53 beforehand.

In Equation 4 “E₂” is an amount of primary energy used per a predetermined time of primary energy used to operate an auxiliary facility for producing secondary energy, and “r_{L2}” represents a facility load factor of the auxiliary facility. “Wⱼ” represents consumed power by one of a plurality of auxiliary facilities, “r_{j_o}” represents an operating rate of the corresponding auxiliary facility, “r_{j_e}” represents an efficiency of the corresponding auxiliary facility, and “T_{L}” represents a load time of the auxiliary facility. The auxiliary facilities can vary and may include devices such as a pressure gauge, a power meter, a controller, a communicator, a flowmeter, a thermometer, a vibrometer, and the like. The load time can be changed appropriately to a time unit for providing a transaction price as needed.

In step S22, the facility load factor and operating rate of auxiliary facilities can be directly input to the data collection unit 51 from controllers managing these facilities. Additionally, the data collection unit 51 can retrieve power consumption data from devices such as pressure gauges, power meters, controllers, communicators, flowmeters, thermometers, vibrometers, and the efficiency of these auxiliary facilities from diagnostic or manual information stored in the database 53. Operating days or hours can be input to the data collection unit 51 by the seller directly entering operational patterns of the facility.

Meanwhile, in step S21, the unit price calculation unit 52 can calculate the unit electricity consumption rate based on the electricity usage computed similar to Equation 3. For instance, applying the one-month operational time according to the driving pattern in Equation 3 allows the computation of the primary energy usage of the secondary energy production facility over the one-month period, which serves as the basis for determining the production cost of the secondary energy for that month. By applying the unit price of primary energy received through the primary energy supplier server to the computed primary energy usage, the production cost of the secondary energy for the one-month period can be determined. The determined production cost of the secondary energy can then be applied as one of the components of the transaction price applied in energy-sharing transactions.

In addition, in step S22, the unit price calculation unit 52 can apply the calculated operating cost of auxiliary equipment for one month, computed via Equation 4, as one item of the transaction unit price applied in energy sharing transactions.

Furthermore, in the unit price calculation step S20, the unit price calculation unit 52 can divide the purchase cost or installation cost of the secondary energy production facility and auxiliary equipment by a pre-set useful life obtained from the database 53, apply the pattern of secondary energy supply, calculate the depreciation expense for one month during the time unit of transaction price calculation, and apply it as one component of the transaction unit price applied in energy sharing transactions.

Furthermore, in the unit price calculation step S20, the unit price calculation unit 52 can apply the maintenance cost of secondary energy within the energy transmission pipe 100, predicted by the prediction data calculation unit 54 on a pre-set time basis such as monthly or seasonal, as one component of the transaction unit price applied in energy sharing transactions.

Additionally, in the unit price calculation step S20, the unit price calculation unit 52 can also receive data regarding maintenance costs for secondary energy production facilities or auxiliary facilities, transaction participation fees, and climate/environmental charges, and calculate each of them as monthly costs based on the operation patterns of the facilities. These costs can then be applied as components of the transaction unit price used in energy sharing transactions.

As described above, the energy price determination apparatus and method for energy- sharing transaction systems according to various embodiments of the present invention can induce changes in the operational patterns of entities receiving secondary energy by determining transaction prices for different types of secondary energy. This allows for the adjustment of peak energy usage times through the formation of various sellers for each type of secondary energy.

Additionally, the energy price determination apparatus and method for energy-sharing transaction systems according to various embodiments of the present invention require inputs such as operating ratios, load rates, and efficiency of older equipment. This ensures transparency of information regarding equipment management and carbon emissions for each entity, enabling the generation of more statistics and reports related to carbon emissions in the manufacturing sector through various market price formations.

Furthermore, the energy price determination apparatus and method for energy-sharing transaction systems according to various embodiments of the present invention can update transaction prices for each trading group based on intent and purpose, in addition to reflecting fluctuations in the cost of primary energy. This allows for the adjustment of usage patterns of entities using secondary energy according to the supplier's patterns.

Moreover, the energy price determination apparatus and method for energy-sharing transaction systems according to various embodiments of the present invention can derive and establish optimal environments and patterns for energy cost reduction on a regional basis among traders and trading factory groups.

Although the present invention has been illustrated and described in connection with a specific embodiment of the present invention, it would be obvious to a person skilled in the art that the present invention can be variously modified and changed without departing from the technical spirit of the present invention provided by the claims below.

What is claimed is:

1. An apparatus for determining an energy unit price applied to an energy sharing transaction system for executing a secondary energy sharing transaction between a buyer and a seller having a secondary energy production facility operated by using a primary energy as a power source to produce a secondary energy, the apparatus comprising:
a data collection unit for collecting a plurality of data used to calculate the energy unit price for the energy sharing transaction;
a prediction data calculation unit which generates maintenance data for maintaining a quality of the secondary energy existing in an energy transportation pipe at a predetermined time interval by accumulating measurement data of a plurality of meters installed in the energy transportation pipe where the secondary energy is transferred, the energy transportation pipe being connected between the secondary energy production facility and a factory of the buyer; and
a unit price calculation unit for calculating the energy unit price of the secondary energy supplied from the secondary energy production facility by using at least a part of the data collected by the data collection unit and at least a part of the data generated by the prediction data calculation unit.

2. The apparatus of claim 1, wherein the plurality of data collected by the data collection unit comprises at least one of:
a unit price of the primary energy used to operate the secondary energy production facility, a supply time pattern and an issue schedule of the secondary energy, diagnosis information and manual information of the secondary energy production facility, the measurement data, a cost or a reward generated when the seller subscribes to the energy sharing transaction system, and a carbon credit payment cost of the seller.

3. The apparatus of claim 1, wherein the plurality of meters comprise at least one of a flowmeter, a manometer, a thermometer and a vibrometer.

4. The apparatus of claim 1, wherein the prediction data calculation unit is adapted to accumulate the measurement data collected in real-time and predict an operation cost of an auxiliary facility for maintaining temperature or pressure in the transportation pipe read from the measurement data at a preset level or higher monthly or seasonally.

5. The apparatus of claim 1, wherein the unit price calculation unit is adapted to calculate an amount of the primary energy used by the secondary energy production facility according to an equation:
$${E}_{1} = \frac{{V}_{p} \times ( {E}_{i} / \sum {E}_{n} ) \times {r}_{L 1} \times {r}_{i}}{{V}_{s}} \times \frac{W}{{r}_{E} \times {r}_{Ei}}$$
wherein
Eᵢ represents a used amount per unit time of one primary energy among a plurality of primary energies used to operate the secondary energy production facility;
Vₚ represents a supplied amount of the secondary energy sold through the energy sharing transaction system;
Eᵢ represents energy amount of a corresponding primary energy;
ΣEₙ represents a summed amount of each energy amount of the plurality of primary energies consumed to produce the secondary energy;
r_{L1} represents a facility load factor of the secondary energy production facility;
rᵢ represents an operating rate of a primary energy production facility 1 if the primary energy production facility does not exist;
Vₛ represents a production capacity of the secondary energy production facility;
W represents a consumption of primary energy per unit time of a preset secondary energy production facility;
r_{E} represents an efficiency of the secondary energy production facility; and
r_{Ei} represents an efficiency of a corresponding primary energy production facility 1 if the primary energy production facility does not exist.

6. The apparatus of claim 5, wherein the unit price calculation unit is adapted to determine the energy unit price of the secondary energy produced by the secondary energy production facility during a predetermined period for calculation of the energy unit price by applying an operational pattern of the primary energy production facility during the period and the unit price of the primary energy.

7. The apparatus of claim 4, wherein the unit price calculation unit is adapted to calculate an amount of the primary energy consumed by the auxiliary facility according to an equation:
$${E}_{2} = \frac{{r}_{L 2} \times \sum ( {W}_{j} \times {r}_{j \_ o} \times {r}_{j \_ e} )}{{T}_{L}}$$
wherein
E₂ represents a used amount per predetermined time of the primary energy used to operate the auxiliary facility;
r_{L2} represents a facility load factor of the auxiliary facility;
Wⱼ represents a consumed power by one of a plurality of the auxiliary facilities;
r_{J_o} represents an operating rate of a corresponding auxiliary facility;
r_{j_e} represents an efficiency of the corresponding auxiliary facility; and
T_{L} represents a load time of the auxiliary facility.

8. The apparatus of claim 1, wherein the unit price calculation unit is adapted to divide a purchase cost or installation cost of the secondary energy production facility and an auxiliary facility by a preset term of usage and apply an supply pattern of the secondary energy to calculate a depreciation cost during a period for calculation of the energy unit price, and then apply the depreciation cost as an item of a transaction price applied to an energy sharing transaction.

9. The apparatus of claim 1, wherein the unit price calculation unit is adapted to apply a cost for maintaining the quality of the secondary energy in the transportation pipe predicted at a predetermined time interval by the prediction data calculation unit as an item of a transaction price applied to an energy sharing transaction.

10. The apparatus of claim 4, wherein the unit price calculation unit is adapted to receive data on maintenance cost for the secondary energy production facility or the auxiliary facility, a transaction participation cost, and an environmental cost and calculate the maintenance cost, the participation cost and the environmental cost corresponding to a period for calculation of the energy unit price based on an operational pattern of a corresponding facility to apply the calculated costs as items of a transaction price applied to the energy sharing transaction.

11. A method for determining an energy unit price applied to an energy sharing transaction system for executing a secondary energy sharing transaction between a buyer and a seller having a secondary energy production facility operated by using a primary energy as a power source to produce a secondary energy, the method comprising:
a data collection step of collecting a plurality of data used to calculate the energy unit price for the energy sharing transaction;
a prediction data calculation step of generating maintenance data for maintaining a quality of the secondary energy existing in an energy transportation pipe at a predetermined time interval by accumulating measurement data of a plurality of meters installed in the energy transportation pipe where the secondary energy is transferred, the energy transportation pipe being connected between the secondary energy production facility and a factory of the buyer; and
a unit price calculation step of calculating the energy unit price of the secondary energy supplied from the secondary energy production facility by using at least a part of the data collected by the data collection step and at least a part of the data generated by the prediction data calculation step.

12. The method of claim 11, wherein the plurality of data collected in the data collection step comprises at least one of:
a unit price of the primary energy used to operate the secondary energy production facility, a supply time pattern and an issue schedule of the secondary energy, diagnosis information and manual information of the secondary energy production facility, the measurement data, a cost or a reward generated when the seller subscribes to the energy sharing transaction system, and a carbon credit payment cost of the seller.

13. The method of claim 11, wherein the plurality of meters comprise at least one of a flowmeter, a manometer, a thermometer and a vibrometer.

14. The method of claim 11, wherein the prediction data calculation step is characterized by accumulating the measurement data collected in real-time and predicing an operation cost of an auxiliary facility for maintaining temperature or pressure in the transportation pipe read from the measurement data at a preset level or higher monthly or seasonally.

15. The method of claim 11, wherein the unit price calculation step is characterized by calculating an amount of the primary energy used by the secondary energy production facility according to an equation:
$${E}_{1} = \frac{{V}_{p} \times ( {E}_{i} / \sum {E}_{n} ) \times {r}_{L 1} \times {r}_{i}}{{V}_{s}} \times \frac{W}{{r}_{E} \times {r}_{Ei}}$$
wherein
E1 represents a used amount per unit time of one primary energy among a plurality of primary energies used to operate the secondary energy production facility;
Vₚ represents a supplied amount of the secondary energy sold through the energy sharing transaction system;
Ei represents energy amount of a corresponding primary energy;
ΣEn represents a summed amount of each energy amount of the plurality of primary energies consumed to produce the secondary energy;
rL1 represents a facility load factor of the secondary energy production facility;
ri represents an operating rate of a primary energy production facility 1 if the primary energy production facility does not exist;
Vs represents a production capacity of the secondary energy production facility;
W represents a consumption of primary energy per unit time of a preset secondary energy production facility;
rE represents an efficiency of the secondary energy production facility; and
rEi represents an efficiency of a corresponding primary energy production facility 1 if the primary energy production facility does not exist.

16. The method of claim 15, wherein the unit price calculation step is characterized by determining the energy unit price of the secondary energy produced by the secondary energy production facility during a predetermined period for calculation of the energy unit price by applying an operational pattern of the primary energy production facility during the period and the unit price of the primary energy.

17. The method of claim 14, wherein the unit price calculation step is characterized by calculating an amount of the primary energy consumed by the auxiliary facility according to an equation:
$${E}_{2} = \frac{{r}_{L 2} \times \sum ( {W}_{j} \times {r}_{j \_ o} \times {r}_{j \_ e} )}{{T}_{L}}$$
wherein
E2 represents a used amount per predetermined time of the primary energy used to operate the auxiliary facility;
rL2 represents a facility load factor of the auxiliary facility;
Wj represents a consumed power by one of a plurality of the auxiliary facilities;
rJ_o represents an operating rate of a corresponding auxiliary facility;
rj_e represents an efficiency of the corresponding auxiliary facility; and
TL represents a load time of the auxiliary facility.

18. The method of claim 11, wherein the unit price calculation step is characterized by dividing a purchase cost or installation cost of the secondary energy production facility and an auxiliary facility by a preset term of usage and applying an supply pattern of the secondary energy to calculate a depreciation cost during a period for calculation the energy unit price, and then applying the depreciation cost as an item of a transaction price applied to an energy sharing transaction.

19. The method of claim 11, wherein the unit price calculation step is characterized by applying a cost for maintaining the quality of the secondary energy in the transportation pipe predicted at a predetermined time interval by the prediction data calculation step as an item of a transaction price applied to an energy sharing transaction.

20. The method of claim 14, wherein the unit price calculation step is characterized by receiving data on maintenance cost for the secondary energy production facility or the auxiliary facility, a transaction participation cost, and an environmental cost and calculating the maintenance cost, the participation cost and the environmental cost corresponding to a period for calculation of the energy unit price based on an operational pattern of a corresponding facility to apply the calculated costs as items of a transaction price applied to the energy sharing transaction.
